(19) United States
(12) Patent Application Publication
(10) Pub. No.: US 2008/0243333 A1
(43) Pub. Date: Oct. 2, 2008

(54) Device operating system, controller, and control program product

(75) Inventors: Takuya Uchiyama, Shinagawa (JP); Satoshi Sakurai, Shinagawa (JP); Shinichiro Akieda, Shinagawa (JP)

Correspondence Address: STAAS & HALSEY LLP, SUITE 700, 1201 NEW YORK AVENUE, N.W., WASHINGTON, DC, 20005, US

(73) Assignee: Fujitsu Component Limited, Tokyo (JP)

(21) Appl. No.: 11/892,403

(22) Filed: Aug. 22, 2007

(30) Foreign Application Priority Data
Mar. 30, 2007 (JP) 2007-092823

(51) Int. Cl. G06F 19/00

(52) U.S. Cl. 701/36

(57) ABSTRACT

A disclosed device operating system controls an operation target device by generating a command for the operation target device. The device operating system includes an operating unit configured to send an instruction to the operation target device by being moved; a movement trace detecting unit configured to detect a movement trace of the operating unit; and a control unit configured to control the operation target device with the command based on the movement trace detected by the movement trace detecting unit.

### BACKGROUND OF THE INVENTION

1. Field of the Invention

The present invention relates to device operating systems, controllers, and control program products, and more particularly to a device operating system, a controller, and a control program product for moving a pointer displayed on a display unit.

2. Description of the Related Art

In recent years and continuing, automobiles are equipped with various devices. Each device installed in an automobile is operated with a different operating device. Thus, the driver needs to change the operating device to operate each device.

For example, to operate an air conditioner, the driver uses switches for operating the air conditioner and to operate an audio system, the driver uses switches for operating the audio system. Although the switches for operating the air conditioner and the switches for operating the audio system are provided in the same area, they are different sets of switches. Accordingly, when a driver is to operate these devices while driving, he needs to grope for the intended set of switches, and control the switches without looking. It is actually difficult for the driver to operate the switches while driving.

Various on-vehicle input devices have been developed in an attempt to improve operability for the driver (see, for example, Patent Documents 1-4).

Patent Document 1: Japanese Laid-Open Patent Application No. H11-278173

Patent Document 2: Japanese Laid-Open Patent Application No. 2000-149721

Patent Document 3: Japanese Laid-Open Patent Application No. 2004-279095

Patent Document 4: Japanese Laid-Open Patent Application No. 2005-96515

There are conventional on-vehicle input devices that feed back a vibration according to an operation so that the user does not need to view the input device. However, such a technology merely lets the user know that an operation has been performed by feeling the vibration.

### SUMMARY OF THE INVENTION

The present invention provides a device operating system, a controller, and a control program product in which one or more of the above-described disadvantages are eliminated.

A preferred embodiment of the present invention provides a device operating system, a controller, and a control program product that can improve operability for a user.

An embodiment of the present invention provides a device operating system for controlling an operation target device by generating a command for the operation target device, the device operating system including an operating unit configured to send an instruction to the operation target device by being moved; a movement trace detecting unit configured to detect a movement trace of the operating unit; and a control unit configured to control the operation target device with the command based on the movement trace detected by the movement trace detecting unit.

An embodiment of the present invention provides a device operating system for controlling an operation target device by generating a command for the operation target device, the device operating system including an operating unit configured to output a signal based on a direction in which the operating unit is being moved, wherein the operating unit is configured to be driven or vibrated; and a control unit configured to control the operation target device with the command based on the signal received from the operating unit and drive or vibrate the operating unit based on a status of the operation target device.

An embodiment of the present invention provides a controller for controlling an operation target device by generating a command for the operation target device based on a user-operated movement of an operating unit used for sending an instruction to the operation target device, the controller including a movement trace detecting unit configured to detect a movement trace of the operating unit; and a control unit configured to control the operation target device with the command based on the movement trace detected by the movement trace detecting unit.

An embodiment of the present invention provides a controller for controlling an operation target device by generating a command for the operation target device based on a user-operated movement of an operating unit that outputs a signal based on a direction in which the operating unit is being moved, wherein the operating unit is configured to be driven or vibrated, the controller including a device control unit configured to control the operation target device with the command based on the signal received from the operating unit; and an operating unit control unit configured to drive or vibrate the operating unit based on a status of the operation target device.

An embodiment of the present invention provides a computer-readable control program product including instructions for causing a computer to perform a movement trace detecting step of detecting a movement trace of an operating unit based on a signal received from the operating unit, wherein the operating unit is configured to output the signal based on a direction in which the operating unit is being moved and also configured to be driven; and a control step of controlling an operation target device based on the movement trace of the operating unit detected in the movement trace detecting step.

An embodiment of the present invention provides a computer-readable control program product including instructions for causing a computer to perform a movement direction detecting step of detecting a movement direction of an operating unit based on a signal received from the operating unit, wherein the operating unit is configured to output the signal based on a direction in which the operating unit is being moved and also configured to be driven; and a page switch control step of switching a control page used for controlling an operation target device displayed on a display device based on the movement direction of the operating unit detected in the movement direction detecting step.

An embodiment of the present invention provides a computer-readable control program product including instructions for causing a computer to perform a signal detecting step of detecting a signal received from an operating unit, wherein the operating unit is configured to output the signal based on a direction in which the operating unit is being moved and also configured to be driven; and a control step of driving the operating unit based on the signal detected in the signal detecting step.

According to one embodiment of the present invention, a device operating system, a controller, and a control program product that can improve operability for a user are provided.

### BRIEF DESCRIPTION OF THE DRAWINGS

Other objects, features and advantages of the present invention will become more apparent from the following detailed description when read in conjunction with the accompanying drawings, in which:

FIG. 1 is a block diagram of a system according to an embodiment of the present invention;

FIG. 2 is a perspective view of an operating device;

FIG. 3 is a separated perspective view of the operating device;

FIG. 4 is a block diagram of parts of the operating device relevant to an embodiment of the present invention;

FIG. 5 is a diagram for describing operations of the operating device;

FIG. 6 is a flowchart of a movement trace detecting process performed by a host computer;

FIGS. 7A-7C illustrate operations of the movement trace detecting process performed by the host computer;

FIG. 8 is a flowchart of an operating process performed by the host computer;

FIGS. 9A, 9B illustrate operations of the operating process performed by the host computer;

FIG. 10 is a flowchart of a process of operating in cooperation with a car navigation system; and

FIG. 11 is a flowchart of a user learning process provided by the host computer.

### DETAILED DESCRIPTION OF THE PREFERRED EMBODIMENTS

A description is given, with reference to the accompanying drawings, of an embodiment of the present invention.

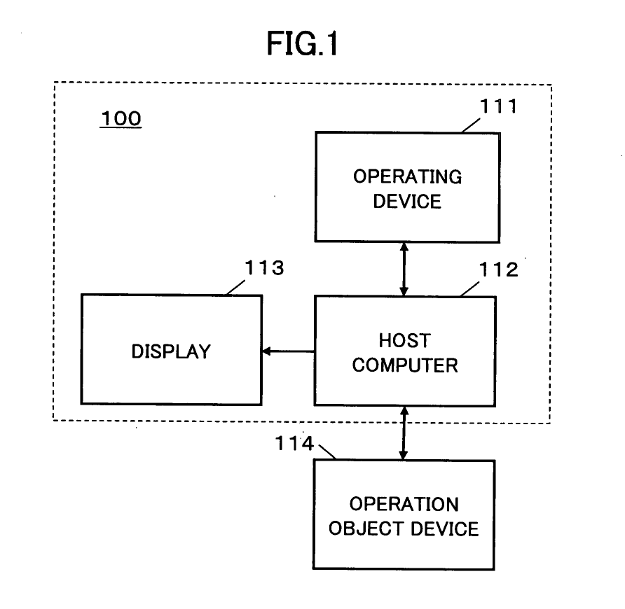

FIG. 1 is a block diagram of a system according to an embodiment of the present invention.

A device operating system 100 according to an embodiment of the present invention is installed in, for example, an automobile, for generating commands for an operation target device 114 such as an air conditioner, an audio system, or a car navigation system to control the operation target device 114. The device operating system 100 includes an operating device 111 for sending an instruction to the operation target device 114, a host computer 112, and a display 113.

The following is a description of the operating device 111.

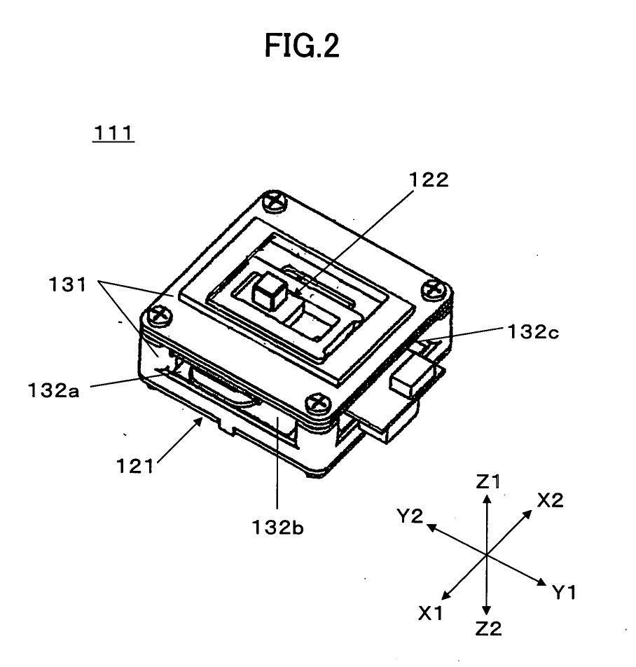

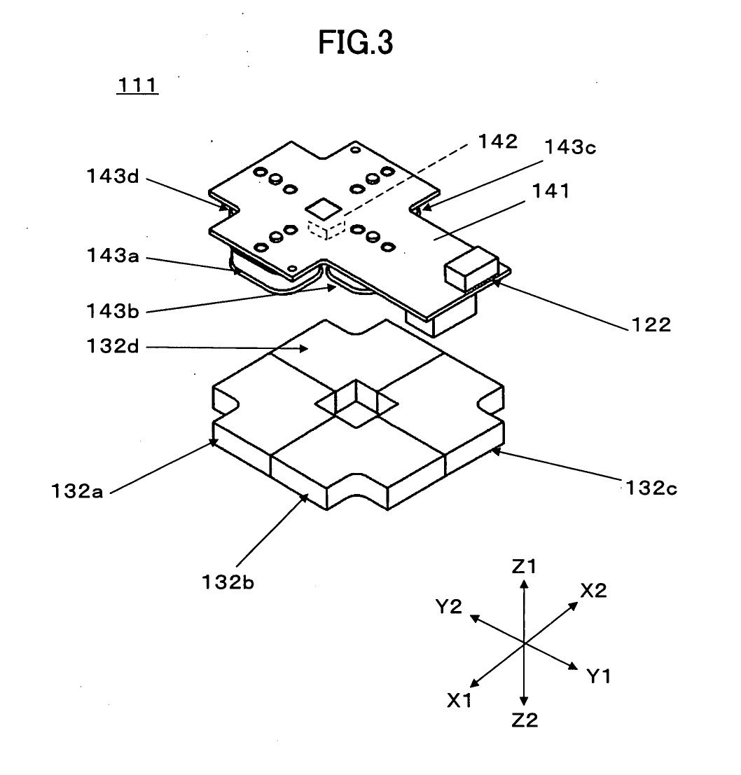

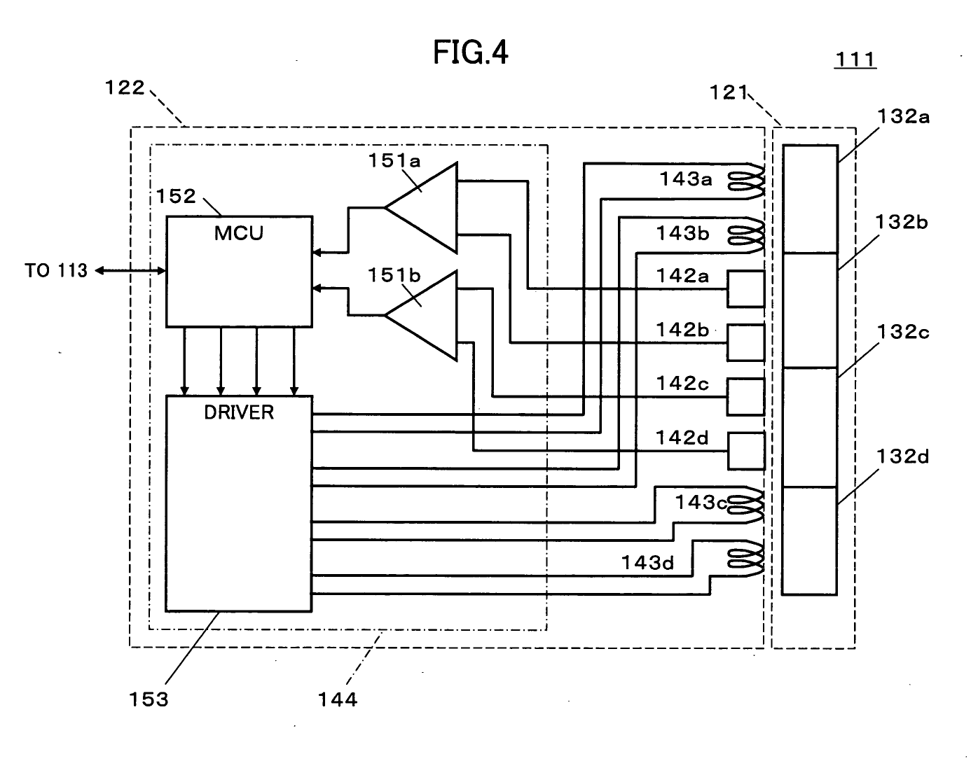

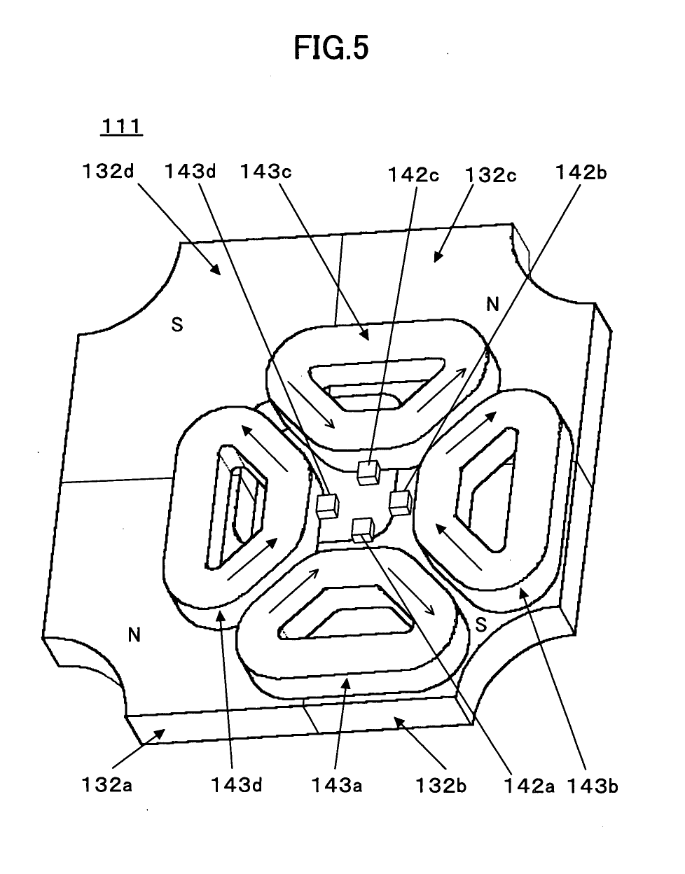

FIG. 2 is a perspective view of the operating device 111, FIG. 3 is a separated perspective view of the operating device 111, FIG. 4 is a block diagram of parts of the operating device 111 relevant to an embodiment of the present invention, and FIG. 5 is a diagram for describing operations of the operating device 111.

The operating device 111 is a so-called tactile actuator, which is fixed to the steering wheel of a car. The operating device 111 outputs position information of an operating section 122 with respect to a fixed section 121 to the host computer 112. In response to drive information received from the host computer 112, the operating section 122 is driven on an X-Y plane.

The fixed section 121 includes magnets 132a, 132b, 132c, and 132d that are fixed to a frame 131 in a ring shape on the X-Y plane. Each of the magnets 132a, 132b, 132c, and 132d is a plate. Adjacent magnets have magnetic poles in a direction perpendicular to the X-Y plane, i.e., in a Z direction, and adjacent magnets are made to have different polarities from each other.

The operating section 122 includes a hole IC 142, coils 143a, 143b, 143c, and 143d, and a controller 144 mounted on a circuit board.

The hole IC 142 has four hole elements 142a, 142b, 142c, and 142d mounted thereon. The hole elements 142a, 142b, 142c, and 142d are connected to the controller 144.

The controller 144 includes amplifiers 151a, 151b, an MCU 152, and a driver 153. The amplifier 151a outputs the difference between the output of the hole element 142a and the output of the hole element 142c. The hole element 142a and the hole element 142c are arranged in, for example, an X axis direction. Output of the amplifier 151a is a signal according to a position along the X axis direction of the operating section 122 with respect to the fixed section 121.

The amplifier 151b outputs the difference between the output of the hole element 142b and the output of the hole element 142d. The hole element 142b and the hole element 142d are arranged in, for example, the X axis direction. Output of the amplifier 151b is a signal according to a position along a Y axis direction.

Outputs from the amplifiers 151a, 151b are supplied to the MCU 152. The MCU 152 creates position information of the operating section 122 with respect to the fixed section 121 based on outputs from the amplifiers 151a, 151b, and supplies the position information to the host computer 112.

The MCU 152 supplies driving signals to the driver 153 based on a driving instruction received from the host computer 112.

The driver 153 supplies driving currents to the coils 143a, 143b, 143c, and 143d based on the driving signals received from the MCU 152. The coils 143a, 143b, 143c, and 143d are arranged facing the magnets 132a, 132b, 132c, and 132d. The coil 143a is arranged across the magnet 132a and the magnet 132b, the coil 143b is arranged across the magnet 132b and the magnet 132c, the coil 143c is arranged across the magnet 132c and the magnet 132d, and the coil 143d is arranged across the magnet 132d and the magnet 132a. The magnets 132a, 132b, 132c, and 132d and the coils 143a, 143b, 143c, and 143d are driven in parallel on the X-Y plane, thus configuring a voice coil motor.

Accordingly, the operating section 122 is moved in the X-Y plane by applying driving currents to the coils 143a, 143b, 143c, and 143d.

The host computer 112 controls displaying operations of the display 113 and operations of the operation target device 114 based on position information received from the operating device 111. The host computer 112 also generates driving instructions for driving the operating section 122 based on information received from the operation target device 114, and supplies the driving instructions to the operating device 111. The operating device 111 drives the operating section 122 based on driving instructions received from the host computer 112.

The following is a description of the host computer 112.

The host computer 112 includes a microcomputer, and can communicate with the operation target device 114 such as an audio system, an air conditioner, or a car navigation system, via a predetermined interface. The host computer 112 can control plural operation object devices 114 such as an audio system, an air conditioner, and a car navigation system in a unified manner. The host computer 112 displays an operation page and a status page indicating the status of a system relevant to the audio system, the air conditioner, and the car navigation system. The host computer 112 controls the operation object devices 114 such as the audio system, the air conditioner, and the car navigation system based on operation information of the operating device 111 received from the controller 144.

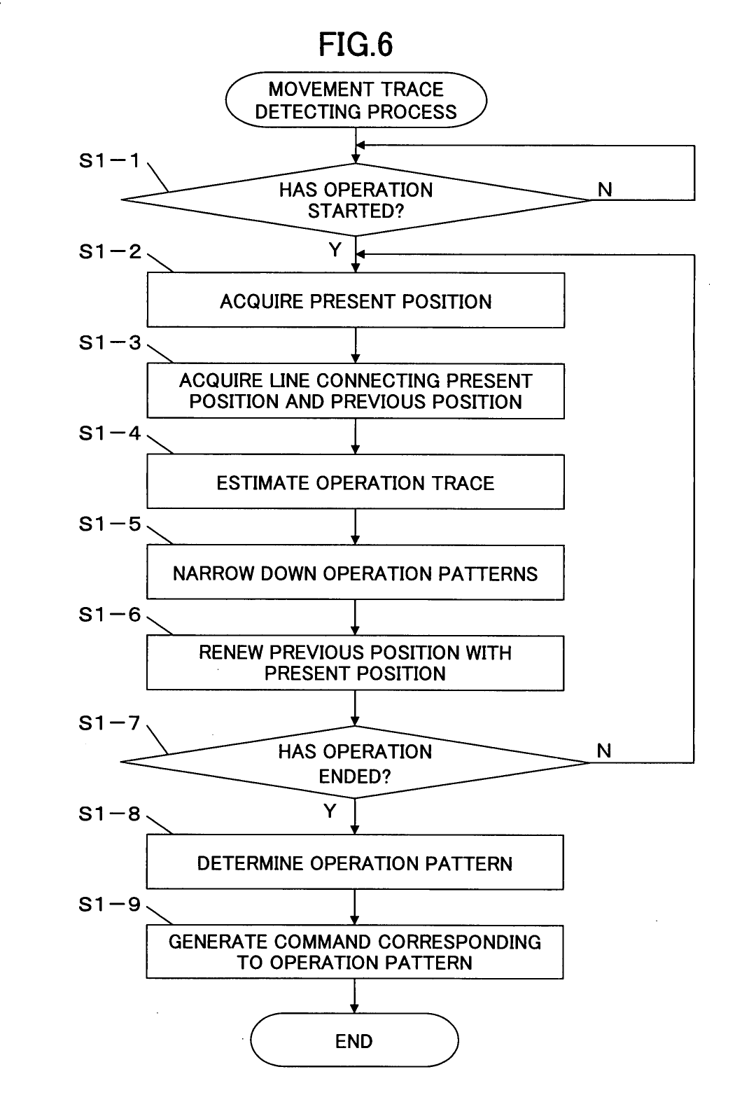

FIG. 6 is a flowchart of a movement trace detecting process performed by the host computer 112.

As a user operates the operating section 122 and the operating section 122 moves in step S1-1, the host computer 112 acquires the present position information of the operating section 122 from the controller 144 in step S1-2. In step S1-3, the host computer 112 compares the acquired present position information with previous position information, and acquires a line connecting the present position and the previous position. In step S1-4, the host computer 112 estimates an operation trace from the line connecting the present position and the previous position. In step S1-5, the host computer 112 narrows down operation patterns based on the estimated operation trace.

In step S1-6, the host computer 112 renews the previous position information with the present position information.

In step S1-7, the host computer 112 determines whether the operation by the user has ended. For example, if the present position and the previous position do not change a predetermined number of times, the host computer 112 determines that the operation has ended.

When it is determined that the operation has ended in step S1-7, the host computer 112 determines an operation pattern in step S1-8. When an operation pattern is determined in step S1-8, the host computer 112 generates a command corresponding to the operation pattern for the operation target device 114 in step S1-9. The operation target device 114 is controlled according to the command generated by the host computer 112.

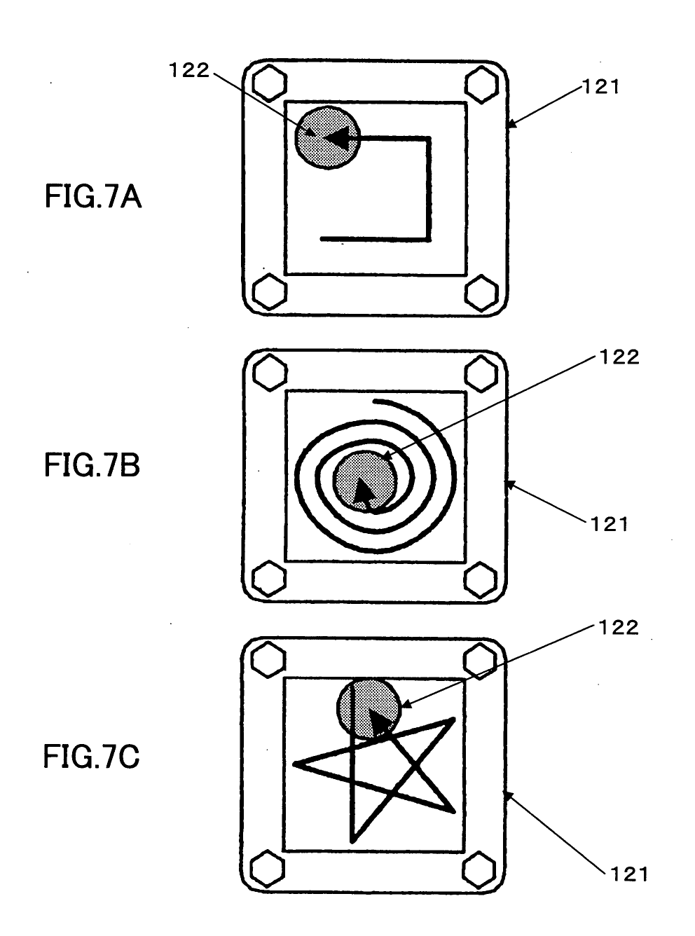

FIGS. 7A-7C illustrate operations of the movement trace detecting process performed by the host computer 112.

For example, when the user moves the operating section 122 in a reversed c shape as illustrated in FIG. 7A, the controller 144 detects this and generates a command for the host computer 112 to turn on the audio system.

When the user moves the operating section 122 in a clockwise spiral manner as illustrated in FIG. 7B, the controller 144 detects this and generates a command for the host computer 112 to turn on the air conditioner.

When the user moves the operating section 122 in a star shape as illustrated in FIG. 7C, the controller 144 detects this and generates a command for the host computer 112 to turn off the car navigation system.

The movement traces are not limited to the shapes shown in FIGS. 7A-7C; the movement traces can be shapes such as a circle, a triangle, and a square, or alphabetical/numeric characters. Furthermore, the host computer 112 can be provided with a learning function so that the combinations of movement traces and commands to be generated can be changed by the user.

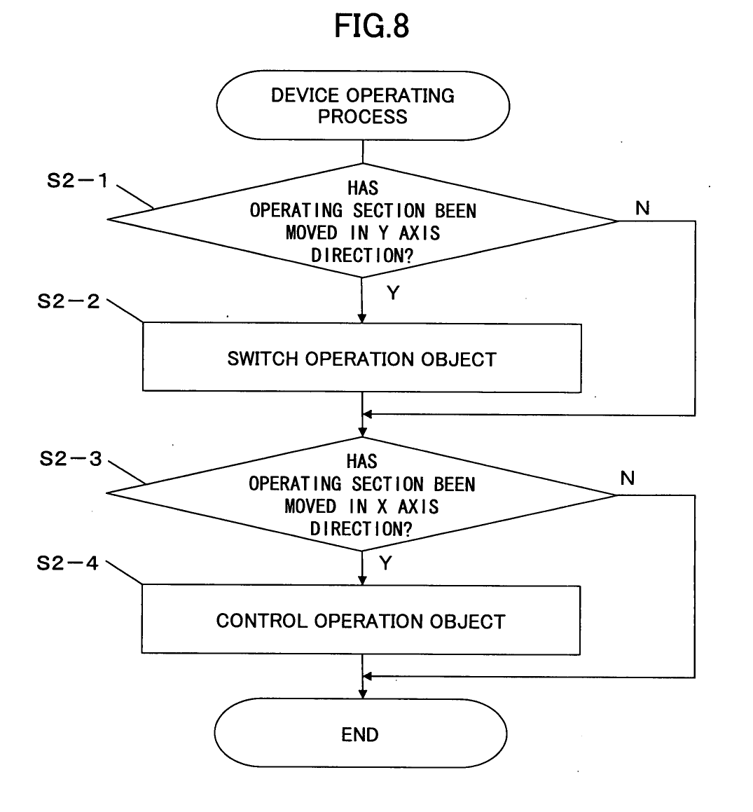

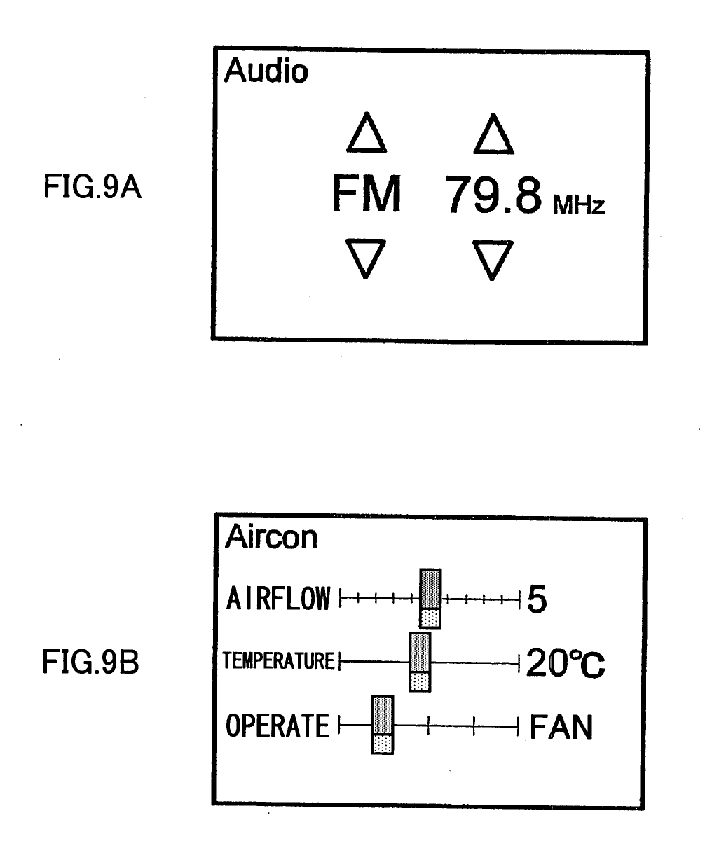

FIG. 8 is a flowchart of an operating process performed by the host computer 112 and FIGS. 9A, 9B illustrate operations of the operating process performed by the host computer 112.

In step S2-1, when the operating section 122 of the operating device 111 is moved in the Y axis direction, in step S2-2, the host computer 112 switches the operation object. In step S2-3, when the operating section 122 of the operating device 111 is moved in the X axis direction, in step S2-4, the host computer 112 adjusts (controls) the selected operation object.

For example, when an audio operating page shown in FIG. 9A is displayed, the band can be switched by moving the operating section 122 in the X axis direction. After the band has been switched, in the audio operating page shown in FIG. 9A, different channels that can be selected are shown by moving the operating section 122 in the Y axis direction, and it is possible to switch to another channel by moving the operating section 122 in the X axis direction.

After the channel has been switched, by moving the operating section 122 in the Y axis direction, the page displayed on the display 113 switches to an air conditioner operating page as shown in FIG. 9B, so that the airflow can be adjusted. The airflow can be adjusted by moving the operating section 122 in the X axis direction. After the airflow has been adjusted, by moving the operating section 122 in the Y axis direction, the air conditioner operating page shown in FIG. 9B displayed on the display 113 switches to a status in which the temperature can be adjusted. Then, the temperature can be adjusted by moving the operating section 122 in the X axis direction. After the temperature has been adjusted, by moving the operating section 122 in the Y axis direction, the air conditioner operating page shown in FIG. 9B displayed on the display 113 switches to a status in which the operation status can be switched. Then, the operation status can be switched by moving the operating section 122 in the X axis direction. By switching the operation status, it is possible to switch the function of the air conditioner among functions such as a cooler, a heater, and a fan.

As described above, plural devices can be controlled without pressing an enter key, etc.

The following describes an operation performed in cooperation with a car navigation system.

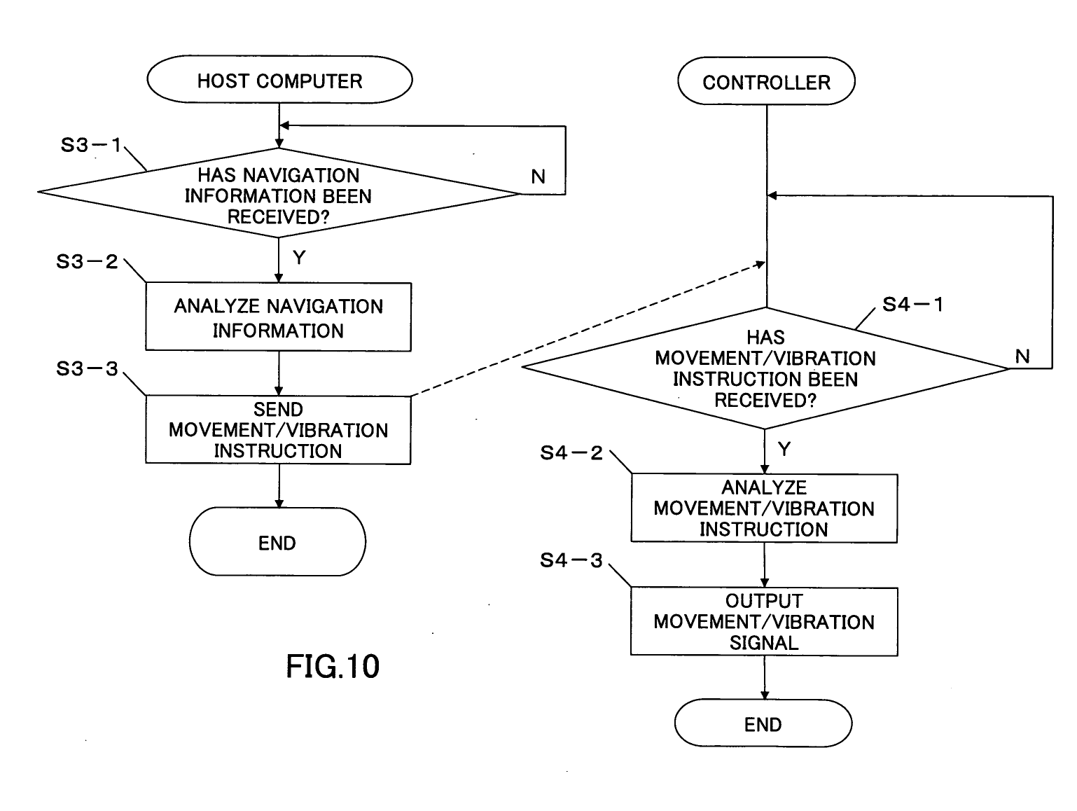

FIG. 10 is a flowchart of a process of an operation performed in cooperation with a car navigation system.

A car navigation system supplies navigation information to the host computer 112 every time the distance from a target location changes by a predetermined amount, every time the traveling direction changes, every time the car passes an intersection, or at predetermined timings.

In step S3-1, when navigation information is received from the car navigation system, in step S3-2, the host computer 112 analyzes the navigation information.

In step S3-3, the host computer 112 supplies, to the controller 144, vibration information corresponding to the traveling direction of the car or the direction in which the car should be traveling or the distance to the target location. For example, if the traveling direction of the car or the direction in which the car should be traveling is a first direction, the operating section 122 supplies to the controller 144, a first movement instruction for moving from a certain direction to the first direction. If the traveling direction of the car or the direction in which the car should be traveling is a second direction, the operating section 122 supplies to the controller 144, a second movement instruction for moving from a certain direction to the second direction.

When a vibration instruction is received from the host computer 112 in step S4-1, the controller 144 analyzes the contents of the instruction in step S4-2. In step S4-3, according to the movement instruction received from the host computer 112, the controller 144 moves the operating section 122 and supplies electric signals to the coils 143a, 143b, 143c, and 143d via the driver 153 in such a manner that the operating section 122 vibrates by a vibration frequency or a vibration size or a vibration pattern corresponding to the vibration instruction.

The user can know the direction in which the car should be traveling just by touching the operating section 122. Furthermore, the user can know the distance to the target location by feeling the vibration of the operating section 122.

Even if the user is not touching the operating section 122, the user can know the distance to the target location, etc., because the vibration of the operating device 111 is transmitted to the user via the steering wheel. It is also possible to make the user know the traveling direction or the direction in which the car should be traveling with the vibration frequency or the vibration size or the vibration pattern of the operating device 111.

The following describes a process performed by the host computer 112 for making a user learn the operations.

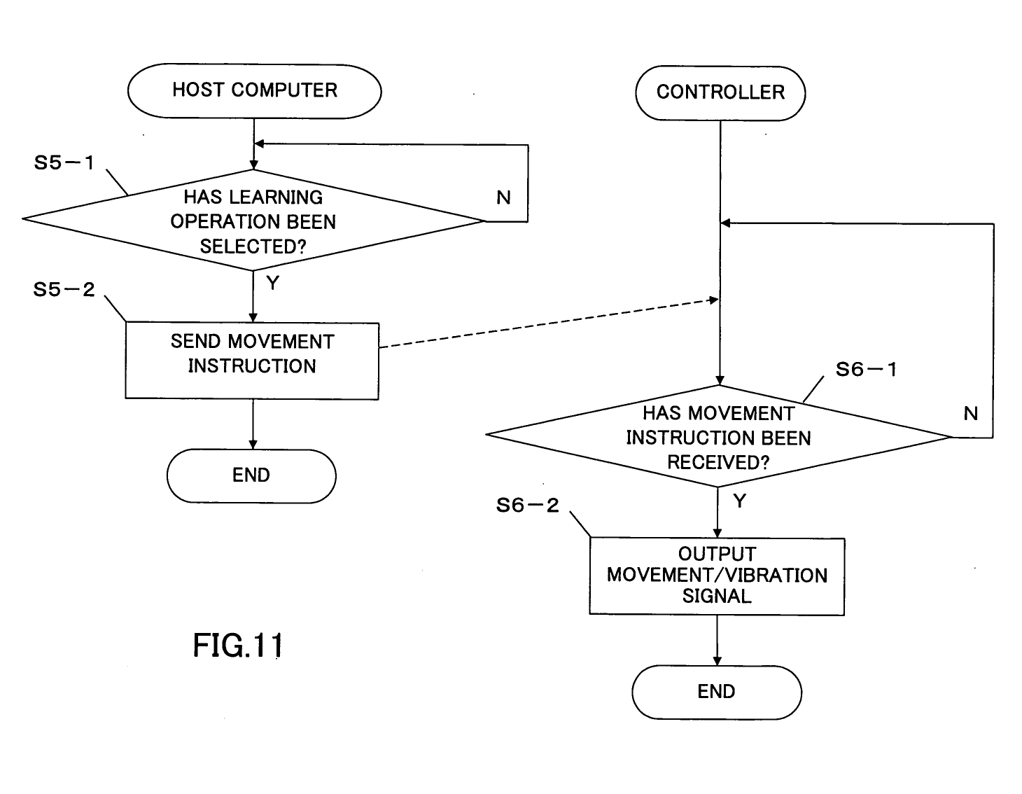

FIG. 11 is a flowchart of a user learning process provided by the host computer 112.

When the user learning process is started up and the user selects a learning operation in step S5-1, the host computer 112 sends a driving instruction to the operating device 111 in step S5-2.

When the driving instruction is received from the host computer 112 in step S6-1, the operating device 111 supplies a driving signal to the driver 153 according to the driving instruction to drive the operating section 122 in step S6-2.

Accordingly, the operating section 122 moves in a movement pattern corresponding to the operation to be learned. For example, the operating section 122 moves in one of the movement patterns illustrated in FIGS. 7A-7C. The user can learn the movement pattern just by feeling the operating section 122 move.

Then, the user can move the operating section 122 according to the learned movement pattern to accomplish a desired operation.

The present invention is not limited to the specifically disclosed embodiment, and variations and modifications may be made without departing from the scope of the present invention.

The present application is based on Japanese Priority Patent Application No. 2007-092823, filed on Mar. 30, 2007, the entire contents of which are hereby incorporated by reference.

What is claimed is:

1. A device operating system for controlling an operation target device by generating a command for the operation target device, the device operating system comprising:
an operating unit configured to send an instruction to the operation target device by being moved;
a movement trace detecting unit configured to detect a movement trace of the operating unit; and
a control unit configured to control the operation target device with the command based on the movement trace detected by the movement trace detecting unit.

2. The device operating system according to claim 1, wherein:
a user-specified movement trace of the operating unit used for controlling the operation target device can be defined in the control unit.

3. The device operating system according to claim 1, further comprising:
a display device configured to display a control page displaying a control status of the operation target device; wherein:
the control unit detects a direction in which the operating unit is being moved based on a signal received from the operating unit and switches the control page displayed on the display device based on the detected direction.

4. A device operating system for controlling an operation target device by generating a command for the operation target device, the device operating system comprising:
an operating unit configured to output a signal based on a direction in which the operating unit is being moved, wherein the operating unit is configured to be driven or vibrated; and
a control unit configured to control the operation target device with the command based on the signal received from the operating unit and drive or vibrate the operating unit based on a status of the operation target device.

5. The device operating system according to claim 4, wherein:
a user-specified pattern of driving or vibrating the operating unit can be defined in the control unit.

6. The device operating system according to claim 4, wherein:
the operation target device comprises a car navigation system; and
the control unit reports to a user a traveling direction of a car by driving or vibrating the operating unit based on information received from the car navigation system, wherein the information indicates the traveling direction of the car.

7. The device operating system according to claim 4, wherein:
the operation target device comprises a car navigation system; and
the control unit drives or vibrates the operating unit in different patterns according to distance information received from the car navigation system, wherein the distance information indicates a distance to a target location.

8. The device operating system according to claim 4, wherein:
the control unit causes the operating unit to move according to the command generated for controlling the operation target device so that a user can learn how to move the operating unit.

9. A controller for controlling an operation target device by generating a command for the operation target device based on a user-operated movement of an operating unit used for sending an instruction to the operation target device, the controller comprising:
a movement trace detecting unit configured to detect a movement trace of the operating unit; and
a control unit configured to control the operation target device with the command based on the movement trace detected by the movement trace detecting unit.

10. The controller according to claim 9, wherein:
a user-specified movement trace of the operating unit used for controlling the operation target device can be defined in the control unit.

11. The controller according to claim 9, wherein:
the control unit detects a direction in which the operating unit is being moved based on a signal received from the operating unit and switches a control page displayed on a display device based on the detected direction.

12. A controller for controlling an operation target device by generating a command for the operation target device based on a user-operated movement of an operating unit that outputs a signal based on a direction in which the operating unit is being moved, wherein the operating unit is configured to be driven or vibrated, the controller comprising:
a device control unit configured to control the operation target device with the command based on the signal received from the operating unit; and
an operating unit control unit configured to drive or vibrate the operating unit based on a status of the operation target device.

13. The controller according to claim 12, wherein:
a user-specified pattern of driving or vibrating the operating unit can be defined in the operating unit control unit.

14. The controller according to claim 12, wherein:
the operation target device comprises a car navigation system; and
the operating unit control unit reports to a user a traveling direction of a car by driving or vibrating the operating unit based on information received from the car navigation system, wherein the information indicates the traveling direction of the car.

15. The controller according to claim 12, wherein:
the operation target device comprises a car navigation system; and
the operating unit control unit drives or vibrates the operating unit in different patterns according to distance information received from the car navigation system, wherein the distance information indicates a distance to a target location.

16. The controller according to claim 12, wherein:
the operating unit control unit causes the operating unit to move according to the command generated for controlling the operation target device so that a user can learn how to move the operating unit.

17. A computer-readable control program product comprising instructions for causing a computer to perform:
a movement trace detecting step of detecting a movement trace of an operating unit based on a signal received from the operating unit, wherein the operating unit is configured to output the signal based on a direction in which the operating unit is being moved and also configured to be driven; and
a control step of controlling an operation target device based on the movement trace of the operating unit detected in the movement trace detecting step.

18. A computer-readable control program product comprising instructions for causing a computer to perform:
a movement direction detecting step of detecting a movement direction of an operating unit based on a signal received from the operating unit, wherein the operating unit is configured to output the signal based on a direction in which the operating unit is being moved and also configured to be driven; and
a page switch control step of switching a control page used for controlling an operation target device displayed on a display device based on the movement direction of the operating unit detected in the movement direction detecting step.

19. A computer-readable control program product comprising instructions for causing a computer to perform:
a signal detecting step of detecting a signal received from an operating unit, wherein the operating unit is configured to output the signal based on a direction in which the operating unit is being moved and also configured to be driven; and
a control step of driving the operating unit based on the signal detected in the signal detecting step.
